(19) United States
(12) Patent Application Publication
(10) Pub. No.: US 2023/0363411 A1
(43) Pub. Date: Nov. 16, 2023

(54) ENZYMOLYSIS PROCESS OF CHICKEN AND APPLICATION OF ENZYMATIC HYDROLYSATE THEREOF IN DOG FOOD

(71) Applicant: FUBEI (SHANGHAI) CO., LTD., Shanghai (CN)

(72) Inventors: Yingchun WANG, Shanghai (CN); Yang REN, Shanghai (CN)

(21) Appl. No.: 18/223,582

(22) Filed: Jul. 19, 2023

Related U.S. Application Data
(63) Continuation of application No. PCT/CN2022/107733, filed on Jul. 26, 2022.

(30) Foreign Application Priority Data
Nov. 2, 2021 (CN) 202111289378.4

(51) Int. Cl. A23K 10/14; A23K 10/20; A23K 50/40

(52) U.S. Cl. CPC A23K 10/14; A23K 10/20; A23K 50/40; C12R 2001/125

(57) ABSTRACT

A process for enzymolysis of chicken includes the follow steps: Step 1, processing chicken into small pieces, transferring the small pieces into a reaction kettle, adding water and preheating; Step 2, stirring the chicken preheated in step 1, raising a temperature to 40 to 60° C., adding protease to perform enzymolysis; and Step 3, heating an enzymatic hydrolysate obtained in step 2 to 85 to 100° C., holding the temperature, and terminating the enzymolysis reaction. The protease is a composite flavourzyme including exo-protease produced by fermentation of Aspergillus oryzae and endo-protease produced by fermentation of Bacillus subtilis.

### CROSS-REFERENCE TO RELATED APPLICATION

This application is a continuation of PCT application serial no. PCT/CN2022/107733, filed on Jul. 26, 2022, which claims the priority and benefit of Chinese patent application serial no. 202111289378.4, filed on Nov. 2, 2021. The entireties of PCT application serial no. PCT/CN2022/107733 and Chinese patent application serial no. 202111289378.4 are hereby incorporated by reference herein and made a part of this specification.

### TECHNICAL FIELD

The present application relates to the field of pet feed, and in particular to a process for mild enzymolysis of chicken and an application of enzymatic hydrolysate thereof in dog food.

### BACKGROUND ART

In current process of meat enzymolysis involved in the field of dog food, aquatic products and livestock meat are selected as the main materials. The main materials are pulverized through a pulverizer, then ground into a meat slurry through a colloid mill, added with a protease and enzymatically hydrolyzed to obtain an enzymatic solution, added with a model excipient, emulsified and cooked simultaneously to obtain a semi-fluid meat slurry, and sterilized to obtain a finished meat slurry. The process enables obtaining a meat enzymatic hydrolysate, but requires adding the model excipients such as egg yolk powder, lecithin, methionine, arginine, starch, etc, as well as cooking at high temperature of 75 to 125° C. and shear emulsion and homogenization on a high-speed shear emulsifier, resulting in complicated operation, time-consuming whole process, high energy consumption and high cost.

A Chinese patent application no. 201710680699.4 discloses a method for preparing a semi-fluid proteolysis meat slurry for dogs and cats. The method includes heating at high temperature of 100° C. for 30 min to cook the meat in a reaction kettle, cooling down to 50 to 60° C. by water, added with NaOH to adjust the pH to 7.0 to 7.5, added with mixed protease, and reacting in constant temperature for 5 to 6 hours to obtain an enzymatic solution. The method has a complicated operation, and requires cooking at high temperature, cooling by water, and a high temperature reaction for 5 to 6 hours, resulting in long time-consuming process, high energy-consumption and high cost.

A Chinese patent application no. 201810484076.4 discloses a expended feed for dogs and cats using enzymatically hydrolyzed meat as the main raw materials and a preparation method therefor. Fresh meat is cooked at 100° C. for 30 min in a reaction kettle and then cooled down to 50 to 60° C., added with mixed protease, and continuous hydrolysed for 5 to 6 hours. The whole process is long time-consuming, high energy-consuming and costly. Further, this method requires adding NaOH to adjust the pH of the reaction system additionally, and introducing another chemical, which is unsafe from the point view of food safety.

A Chinese patent application no. 201110175855.4 discloses a method of preparing chicken protein enzymatic solution and chicken protein enzymatic solution prepared therefrom. Clean raw chicken pieces are crushed, submerged in water, cooked at 80 to 100° C. for 15 to 30 min, cooled down to 50 to 55° C., adjusted the pH to 6.8 to 7.2, added with protease, and then enzymatically hydrolyzed at 50 to 55° C. for 2 to 3 hours. The whole process is long time-consuming, high energy-consuming and costly.

### SUMMARY

In view of this, an objective of this present application is to provide a process for mild enzymolysis of chicken and application of enzymatic hydrolysate thereof in dog food. The palatability of the dog food prepared by the process of the present application is significantly improved, and the present process requires fewer steps, shorter production cycle, lower energy consumption and lower cost.

In order to achieve the above objective, the present application provides the following technical solution:
a process for enzymolysis of chicken, including the follow steps:
Step 1, processing chicken into small pieces, transferring to a reaction kettle, adding water and preheating;
Step 2, stirring the chicken preheated in step 1, raising a temperature to 40 to 65° C., and adding a protease to perform enzymolysis; and
Step 3, heating an enzymatic hydrolysate obtained in step 2 to 85 to 100° C., holding the temperature, and terminating the enzymolysis; in which,
in Step 3, the protease is a composite flavourzyme, including exo-protease produced by fermentation of Aspergillus oryzae and endo-protease produced by fermentation of Bacillus subtilis. The pH is kept at 5.5 to 7.0 in step 1.

A time of enzymolysis is 10 to 60 min in Step 2. The time of time of enzymolysis is set as 10 to 60 min, mainly taking into consideration a flavour and fluidity of the enzymatic hydrolysate, which is to be added to the dog food as raw material. If the time of enzymolysis is shorter than this value, the enzymatic hydrolysate has poor fluidity, and if the time of enzymolysis is longer than this value, there will be an excessively high hydrolysis degree, the flavour will become bitter and the water content is too much, making the enzymatic hydrolysate not suitable for the production of dog food.

The temperature is held for 10 to 30 min in Step 3.

A mass ratio of the chicken to the composite flavourzyme is 1000:0.5 to 1000:8 in Step 1.

A mass ratio of the chicken to the water is 1.5 to 6.

A mass ratio of the exo-protease to the endo-protease is 2:5 to 7:4.

The chicken is chicken breast.

The water is distilled water.

An application of the process for enzymolysis of chicken in the prepared dog food also falls within the scope of protection of the present application.

Compared with related technologies, the present application can achieve at least one of the following beneficial effects:

(1) By adding the protease to the chicken in the reaction kettle for enzymolysis and further optimizing the process conditions, the enzymolysis process of chicken can provide the enzymatic hydrolysate with a pleasant aroma.

(2) The process of the present application can prepare a dog food having significantly improved palatability, and involves in fewer steps, shorter production cycle, lower energy consumption and lower cost.

(3) The composite flavourzyme in the preparation process of the present application is composited by polypeptide exo-protease and endo-protease. The endo-protease can promote dissolution of the chicken breast protein, which only hydrolyze the protein into small molecule peptides, and the small molecule peptides contain some hydrophobic amino acids with bitter taste. The polypeptide exo-protease gradually degrades the amino acid residues from amino terminus or carboxyl terminus of the protein, reducing the bitter taste. The product of this composite flavourzyme hydrolysis of chicken breast has no any bitter taste, which is suitable for the dog food production.

### DETAILED DESCRIPTION

The present application is described in detail by following embodiments. The following embodiments are enable to assist those skilled in the art for further understanding the present application, which are not intended to limit the present application in any forms. It should be noted that to those skilled in the art, several adjustments and improvements are enable to be made without departing from the conception of the present application. And all of these fall within the protection scope of the present application.

The specific technical solution of the present application is as follows:

Step 1, thawing the chicken into fresh raw material, processing the fresh raw material into small pieces through a meat grinder, transferring into a reaction kettle, adding water and preheating, in which the pH is kept at 5.5 to 7.0.

Step 2, starting stirring, raising a temperature to 40 to 65° C. and holding the temperature.

Step 3, adding protease and performing enzymolysis for 10 to 60 min.

Step 4, raising the temperature to 85 to 100° C., holding the temperature for 10 to 30 min, and terminating the enzymolysis reaction.

The protease is a composite flavourzyme, and the composite flavourzyme comprising including exo-protease produced by fermentation of Aspergillus oryzae and endo-protease produced by fermentation of Bacillus subtilis.

### Example 1

500 g of pulverized chicken breast was transferred into a reaction kettle, added with 112.5 g of water and preheated, kept at a pH of 5.5, stirred when a stirrer was able to be rotated, heated to 50° C., kept at the temperature, and added with 1 g of exo-protease produced by fermentation of Aspergillus oryzae and endo-protease produced by fermentation of Bacillus subtilis, in which a mass ratio of the exo-protease to endo-protease is 7:4, enzymatically hydrolyzed for 60 min, then heated to 85° C., and kept at the temperature for 30 min. Then the protease was inactivated to terminate the enzymolysis reaction to obtain an enzymatic hydrolysate. The hydrolysis degree of the chicken breast under this condition was 23.88%, and the enzymatic hydrolysate had a strong aroma of cooked chicken, without any bitter taste.

### Example 2

500 g of pulverized chicken breast was transferred into a reaction kettle, added with 112.5 g of water and preheated, kept at a pH of 7.0, stirred when a stirrer was able to be rotated, heated to 55° C., kept at the temperature, added with 1.25 g of exo-protease produced by fermentation of Aspergillus oryzae and endo-protease produced by fermentation of Bacillus subtilis, in which a mass ratio of the exo-protease to the endo-protease is 7:4, enzymatically hydrolyzed for 45 min, then heated to 100° C., and kept at the temperature for 20 min. Then the protease was inactivated to terminate the enzymolysis reaction to obtain an enzymatic hydrolysate.

The hydrolysis degree of the chicken breast under this condition was 25.04%, and the enzymatic hydrolysate had a strong aroma of cooked chicken, without any bitter taste.

### Example 3

500 g of pulverized chicken breast was transferred into a reaction kettle, added with 112.5 g of water and preheating, kept at a pH of 6.0, stirrer when a stirrer was able to be rotated, heated to 60° C., kept at the temperature, added with 1.5 g of exo-protease produced by fermentation of Aspergillus oryzae and endo-protease produced by fermentation of Bacillus subtilis, in which a mass ratio of the exo-protease to endo-protease is 7:4, enzymatically hydrolyzed for 45 min, then heated to 100° C., and kept at the temperature for 30 minThe protease was inactivated to terminate the enzymolysis reaction to obtain an enzymatic hydrolysate. The hydrolysis degree of the chicken breast under this condition was 26.16%, and the enzymatic hydrolysate had a strong aroma of cooked chicken and good fluidity, without any bitter taste.

### Example 4

500 g of pulverzied chicken breast was transferred into the reaction kettle, added with 125 g of water, preheated, kept at a pH of 5.5, stirrer when a stirrer was able to be rotated, heated to 55° C., kept at the temperature, added with 0.25 g of exo-protease produced by fermentation of Aspergillus oryzae and endo-protease produced by fermentation of Bacillus subtilis, in which a mass ratio of the exo-protease to the endo-protease is 2:5, enzymatically hydrolyzed for 35 min, then heated to 85° C., kept at the temperature for 20 min. The protease was inactivated to terminate the enzymolysis reaction to obtain an enzymatic hydrolysate. The hydrolysis degree of the chicken breast under this condition was 23.35%, and the enzymatic hydrolysate had a strong aroma of cooked chicken.

### Example 5

500 g of pulverzied chicken breast was transferred into a reaction kettle, added with 112.5 g of water, preheated, kept at a pH of 7.0, stirrer when a stirrer was able to be rotated, heated to 55° C., kept at the temperature, added with 1.8 g of exo-protease produced by fermentation of Aspergillus oryzae and endo-protease produced by fermentation of Bacillus subtilis, in which a mass ratio of the exo-protease to the endo-protease is 2:5, enzymatically hydrolyzed for 60 min, then heated to 100° C., kept at the temperature for 20 min. The protease was inactivated to terminate the enzymolysis reaction to obtain an enzymatic hydrolysate. The hydrolysis degree of the chicken breast under this condition was 24.06%, and the enzymatic hydrolysate had a strong aroma of cooked chicken, without any bitter taste.

### Example 6

500 g of pulverzied chicken breast was transferred into a reaction kettle, added with 137.5 g of water, preheated, kept at a pH of 5.5, stirrer when a stirrer was able to be rotated, heated to 65° C., kept at the temperature, added with 1.6 g of exo-protease produced by fermentation of Aspergillus oryzae and endo-protease produced by fermentation of Bacillus subtilis, in which a mass ratio of the exo-protease to the endo-protease is 2:5, enzymatically hydrolyzed for 45 min, then heated to 100° C., and kept at the temperature for 20 min. The protease was inactivated to terminate the enzymolysis reaction to obtain an enzymatic hydrolysate. The hydrolysis degree of the chicken breast under this condition was 22.30%, and the enzymatic hydrolysate had a strong aroma of cooked chicken and certain fluidity, without any bitter taste.

### Example 7

500 g of pulverzied chicken breast was transferred into a reaction kettle, added with 150 g of water, preheated, kept at a pH of 7.0, stirrer when a stirrer was able to be rotated, heated to 40° C., kept at the temperature, added with 4 g of exo-protease produced by fermentation of Aspergillus oryzae and endo-protease produced by fermentation of Bacillus subtilis, in which a mass ratio of the exo-protease to the endo-protease is 2:5, enzymatically hydrolyzed for 10 min, then heated to 100° C., and kept at the temperature for 10 min. The protease was inactivated to terminate the enzymolysis reaction to obtain an enzymatic hydrolysate. The hydrolysis degree of the chicken breast under this condition was 24.90%, and the enzymatic hydrolysate had a strong aroma of cooked chicken and good fluidity, without any bitter taste.

### Comparative Example 1

The comparative example 1 used chicken breast without being subjected to enzymolysis, which had no fluidity.

### Comparative Example 2

The Comparative example 2 differed from Example 2 in that, the protease used was liquid alkaline protease. The hydrolysis degree of the chicken breast under this condition was 31.58%, but the enzymatic hydrolysate had a moderate-intensity bitter taste and was too thin.

### Comparative Example 3

The Comparative example 3 differed from Example 2 in that, the protease was only the exo-protease produced by fermentation of Aspergillus oryzae, and the hydrolysis degree of the chicken breast under this condition was 14.58%, but the enzymatic hydrolysate was thick and had no fluidity.

### Comparative Example 4

The Comparative example 4 differed from Example 2 in that, the protease was only the endo-protease produced by fermentation of Bacillus subtilis, and the hydrolysis degree of the chicken breast under this condition was 41.16%, but the enzymatic hydrolysate had a strong bitter taste and was too thin.

### Comparative Example 5

The Comparative example 5 differed from Example 2 in that, the protease used was powdered protease, and the hydrolysis degree of the chicken breast under this condition was 27.58%, but the enzymatic hydrolysate had a medium bitter taste and was thin.

### Comparative Example 6

The Comparative example 6 differed from Example 2 in that, the enzymolysis temperature was 35° C., and the hydrolysis degree of the chicken breast under this condition was 14.39%, but the enzymatic hydrolysate had no bitter taste, no fluidity and was thick.

### Comparative Example 7

The Comparative example 7 differed from Example 2 in that, the time of enzymolysis was 2 h, and the hydrolysis degree of the chicken breast under this condition was 54.74%, but the enzymatic hydrolysate had no bitter taste, shown as watery, and was too thin.

Comparative Verification of the Palatability Effect

The palatability test was conducted on the products prepared by Example 7 and Comparison example 7.

Twenty small dogs (like Teddy, Bichon, Corgi and other small dogs) were selected and kept in the same kennel, and fed test dog food (with 10% of the enzymatic hydrolysate prepared in Example 7) and control dog food (with 10% of the enzymatic hydrolysate prepared in Comparison example 7) for 4 days each, and the palatability test was processed twice. The first pick, final pick and ingestion ratio of each dog were recorded daily, and then statistical analysis was performed.

Testing Index

(1) The first pick: The test dogs entered a cage with two basins, one was filled with the test dog food, another was filled with the control dog food. And the first pick is the group of dog food which is selected by smell of the test dogs, and ingested first in 1 to 2 min.

(2) The ingestion ratio: The ingestion ratio is a ratio of two groups of dog food after the test dog ingested for 30 minutes from the start of the test, i.e. the ingestion ratio=ingestion amount (g) of group A/ingestion amount (g) of group B.

(3) The final pick: The final pick is the group of dog food which is ingested more by the test dogs finally, after 30 min from the test started. (The difference value of ingestion by the two groups was greater than or equal to 15 g).

The test results (as shown in Table 1) indicated that the palatability of the group prepared in Example 7 which adding 10% enzymatic hydrolysate of chicken breast was significantly better than the group prepared in Comparison example 7 which adding 10% enzymatic hydrolysate of chicken breast.

TABLE 1
Comparison of the palatability after feeding the group
of test dog food and the group of control dog food

The group of control dog food

| The group of test | The first | The final | The ingestion |
|---|---|---|---|
| dog food | pick | pick | ratio |
| The first day | 8/2 | 8/1 | 759/274 |
| The second day | 8/2 | 7/2 | 593/274 |
| The third day | 7/3 | 7/1 | 608/196 |
| The forth day | 6/4 | 6/3 | 570/230 |

Specific embodiments of the present application have been described above. It should be noted that the present application is not limited to the above specific embodiments, and those skilled in the art may make various improvements or modifications within the scope of the claims, which do not affect the substance of the present application.

What is claimed is:

1. A process for enzymolysis of chicken, comprising the follow steps:
Step 1, processing chicken into small pieces, transferring to a reaction kettle, adding water and preheating;
Step 2, stirring the chicken preheated in step 1, raising a temperature to 40 to 65° C., and adding a protease to perform enzymolysis; and
Step 3, heating an enzymatic hydrolysate obtained in step 2 to 85 to 100° C., holding the temperature, and terminating the enzymolysis;
wherein, in Step 2, the protease is a composite flavourzyme comprising exo-protease produced by fermentation of Aspergillus oryzae and endo-protease produced by fermentation of Bacillus subtilis.

2. The process for enzymolysis of chicken according to claim 1, wherein a pH is kept at 5.5 to 7.0 in Step 51.

3. The process for enzymolysis of chicken according to claim 1, wherein a time for the enzymolysis is 10 to 60 min in Step 2.

4. The process for enzymolysis of chicken according to claim 1, wherein the temperature is held for 10 to 30 min in Step 3.

5. The process for enzymolysis of chicken according to claim 1, wherein a mass ratio of the chicken to the composite flavourzyme is 1000:0.5 to 1000:8 in Step 2.

6. The process for enzymolysis of chicken according to claim 1, wherein a mass ratio of the chicken to the water is 1.5 to 6 in Step 1.

7. The process for enzymolysis of chicken according to claim 1, wherein a mass ratio of the exo-protease to the endo-protease is 2:5 to 7:4 in Step 2.

8. The process for enzymolysis of chicken according to claim 1, wherein the chicken is chicken breast.

9. The process for enzymolysis of chicken according to claim 1, wherein the water is distilled water.

10. An application of the process for enzymolysis of chicken according to claim 1 in preparing dog food.
